(19) United States
(12) Patent Application Publication
(10) Pub. No.: US 2009/0147913 A1
(43) Pub. Date: Jun. 11, 2009

(54) X-RAY SCANNER

(75) Inventors: Dirk Dragon, Bruehl (DE); Christoph Clemens Grohmann, Blankenheim (DE)

Correspondence Address: COLLARD & ROE, P.C., 1077 NORTHERN BOULEVARD, ROSLYN, NY, 11576, US

(73) Assignee: GROHMANN TECHNOLOGIES GMBH, BLANKENHEIM (DE)

(21) Appl. No.: 12/226,306

(22) PCT Filed: Apr. 13, 2007
(86) PCT No.: PCT/DE2007/000651

§ 371 Date: Dec. 11, 2008

Related U.S. Application Data
(60) Provisional application No. 60/794,466, filed on Apr. 24, 2006.

(30) Foreign Application Priority Data
Apr. 13, 2006 (DE) 10-2006-017-967.6
Oct. 25, 2006 (DE) 10-2006-051-087.9

(51) Int. Cl. G01N 23/04

(52) U.S. Cl. 378/57

(57) ABSTRACT

The invention proposes a much improved X-ray scanner for large objects. These relate to both safety aspects for the service personnel of the system and safety aspects for the operating personnel of the large object to be scanned, as well as aspects which make possible improved image acquisition.

The invention relates to an X-ray scanner. The invention relates in particular to an X-ray scanner for large objects such as containers, railway wagons or trucks.

The task of scanning large objects such as containers, railway wagons or trucks for impermissible contents regularly arises, particularly in connection with increasing efforts to protect against crime. For example, smuggled goods, or goods potentially supporting terrorism, such as explosives, can be detected in such large objects.

Since it would be very complicated, and hence impracticable, to inspect such large objects in detail on the inside, mobile and stationary stations with X-ray scanners have been established. These scan the loading unit of the large object, in most cases with X-ray radiation. It can then be detected by an operator and/or an automatic EDP detection system, on the basis of the silhouette and/or the scatter image of the radiation, whether impermissible goods are present in the large object.

EP 0 491 977 B1 discloses a test installation for loading of a truck in which the wheels of the towing vehicle are raised by a platform floor truck and the entire truck is driven in this manner through the test installation. In this case an Radiation source is let into the floor and radiates vertically upwards, a suitable detector being provided at the top so that a truck which has passed through the path of rays by means of the platform floor truck can be X-rayed. The problem that arises in this particular case is that it is difficult to widen the beam within a short distance below a support for the truck sufficiently for the entire truck to be detected. Ultimately this means that the radiation source must be arranged at a relatively low level beneath the support.

DE 10 2005 055 129 A1 also discloses a relatively expensive structure in which a complete truck is conveyed through a tomograph. This requires an extremely complex substructure, since the tomograph comprises a vertical support ring which encloses the truck and supports both a detector device and an Radiation source. The ring can then be rotated around the truck for the tomography, the truck passing through the ring in stages. This procedure is extremely time-consuming and is impracticable, particularly in ports or container railway stations where several thousands of containers or trucks per day have to be scanned at one transhipment point. In this arrangement the radiation source is also arranged in the mean time above the truck, which requires the use of the expensive structure since the detector device is arranged underneath the truck.

U.S. Pat. No. 6,542,580 B1 discloses a detection frame in which the radiation source is arranged at the top of the frame. The detectors are installed in the lateral sections of the frame and at the bottom of the sensor system. In this embodiment a relatively high overall height must also be allowed for to be able to scan an entire vehicle. Because of the arrangement of the detectors below the support a complex slide and roller system is also required in order for the motor vehicle to be X-rayed.

The disadvantages of both the aforementioned arrangements are eliminated by a test installation according to DE 40 23 413 A1, in which a separate container is constructed. The container comprises an operating area and a measuring tunnel. A ramp and a conveyor belt leading to the measuring tunnel are constructed for the trucks to be scanned, an Radiation source being arranged in the container on one side of a corresponding support, and suitable detectors being arranged on the other of the two sides. Although this obviates the need for expensive super- and substructures due to the arrangement of the radiation source, the overall arrangement is expensive to construct because the vehicles to be X-rayed have to cross the container.

FR 2 808 088 A1 discloses a mobile X-ray unit which is installed on a truck specially converted for this purpose. The measuring tunnel is defined by a gate that can be swivelled back by the truck. The gate consists of a post with detectors and a bolt with detectors. At the same time an Radiation source is positioned on the side of the truck. An expensive substructure can therefore be avoided.

EP 1 635 169 A1 and U.S. Pat. No. 6,843,599 B2 also disclose a transport truck with a detachable frame which is fitted with X-ray detectors. Trucks passing through are X-rayed with an Radiation source on the extended part of the frame. The radiation source is small and can be generated in different positions.

U.S. Pat. No. 6,928,141 B2 discloses a freestanding stable frame on which are arranged both an Radiation source and detectors. A truck can pass through the frame. The entire frame is conveyed flat against a transport truck to the point of application and maintained there, running on a rail on one side and on wheels on the other side. A complex substructure can also be dispensed with in this arrangement.

DE 11 2004 001 701 T5 also discloses the lateral arrangement which is constructed correspondingly easily.

Further X-ray systems are known from the publications EP 0 491 977 B1, DE 43 11 174 A1, U.S. Pat. No. 3,766,387, DE 40 23 413 A1, U.S. Pat. No. 2,831,123, US 2004/0125914, WO/05.057196 A1, U.S. Pat. No. 6,031,890, FR 2 808 088 A1, U.S. Pat. No. 4,150,293, U.S. Pat. No. 5,367,522, DE 42 10 516 A1, U.S. Pat. No. 4,349,740, U.S. Pat. No. 4,303,830, DE 40 23 414 A1, EP 0 963 925 A2, EP 0 963 925 B1, EP 0 991 916 B1, EP 1526 392 A2, EP 1 635 169 A1, GB 2337632 A, US 2003/0023592, U.S. Pat. No. 6,812,426 B1, WO 03/027653 A2, WO 03/027653 A3, U.S. Pat. No. 6,839,403 B1, U.S. Pat. No. 6,928,141 B2, U.S. Pat. No. 6,815,790 B2, U.S. Pat. No. 6,843,599 B2, U.S. Pat. No. 6,665,373 B1, U.S. Pat. No. 6,542,580 B1, U.S. Pat. No. 6,473,487 B1, U.S. Pat. No. 6,094,472 and from U.S. Pat. No. 5,181,234 B1.

The object of the invention is to make available an X-ray scanner for large objects such as containers, railway wagons or trucks, with at least one laterally arranged Radiation source and at least one detector between which rays are able to run along a ray path, which scanner supplies very clear X-ray images whilst retaining the relatively simple design resulting from this.

According to a first aspect of the invention this object is achieved by an X-ray scanner for large objects such as containers, railway wagons or trucks, with at least one laterally arranged Radiation source and at least one detector between which rays are able to run along a ray path, and with a support for the large object, the support being arranged inside the ray path.

Conceptually the invention may first be explained by stating that the sum of the straight rays which run from the radiation source to a detector is summarised under the term “ray path”. Here it must be considered that the radiation source is not an exactly punctiform Radiation source but it often approximates a punctiform Radiation source. In any case, however, a geometry is obtained in which the radiation source is substantially smaller than a detection line along the detectors. This gives rise to the geometry of the ray path in the plane of the radiation source and of the detectors as a ray field which is very narrow at the radiation source and widens considerably towards the detectors. Normal angles of widening of the ray path lie between approximately 35° (cf. U.S. Pat. No. 6,843,599 B2) and approx. 80° (cf. EP 1 635 169 A1).

With the proposed first aspect of the invention it is possible to X-ray the entire large object and scan for impermissible contents. This also relates, in particular, to regions of the large object to be scanned, arranged at a very low level, such as the wheels of a truck, the substructure of a railway wagon or the storage space of a container. On the other hand, the wheels are not detected by the ray path even in the case of EP 0 491 977 B1. The same applies to DE 11 2004 001 701 T5. In U.S. Pat. No. 6,542,580 B1 the radiation source is not arranged laterally.

It must be emphasised here that the inventive arrangement suffices with a detector and/or Radiation source unit that can only be displaced horizontally or with a large object that can only be displaced horizontally, and, in particular, a vertically displaceable Radiation source is not required to scan a complete image.

The ray path advantageously has at least one horizontal ray trace which is provided underneath the support. If the radiation source is arranged at a suitably low level and if the detectors also extend to a suitable low level, a horizontal ray trace under the support is also automatically provided. The support therefore lies in the ray path in any case without the support having to be placed in a particularly high position, and also without requiring complex platform structures, as in EP 0 491 977 B1 or DE 40 23 413 A1.

The radiation source is preferably arranged in and/or below a plane incorporating the support. Conceptually a flat support surface is assumed for this purpose, which appears logical for this reason alone because the large objects to be scanned are generally provided for standing on a flat surface, e.g. in the case of a truck on a road surface, or in the case of a railway wagon on two rails.

If the radiation source is arranged in the plane of the support a horizontal ray trace is provided through the support and hence through the lowest point of the large object to be scanned. In the case of a truck the contact surface of the tyres would then be exactly adjacent to a horizontal ray trace.

It is particularly advantageous, however, for the radiation source to be arranged actually underneath the support plane. In this manner the entire large object can be X-rayed with a ray trace which deviates from the horizontal. Horizontal regions of the large object, such as the bottom plate of a truck, a railway wagon or a container, can therefore be effectively X-rayed and do not result in linear shading in the silhouette of the radiation.

The support preferably comprises a linear conveyor for the large objects or is designed as such. In both cases the radiation source and/or the detectors may be of a stationary design, and the large object can be conveyed linearly through the ray path.

However, it is also advantageous for the radiation source and the detectors to be linearly displaceable, preferably on rails. In the case of such a structure the paths of the radiation source and detectors can be accurately predetermined and known, which may result in highly precise measured results. Here a displaceable scanner and a linearly conveying support must be mutually exclusive. Instead both these design variants, when used simultaneously, may result in a highly compact structure of the X-ray scanner.

In order to be able to use the scanner in as variable a manner as possible it is proposed that the ray path be provided outside a building. The radiation source and the detectors may then cover any distances, for example they may be displaced along the entire train and scan it fully.

In the case of a scanner whose ray path is provided outside a building, and which is displaceably designed, it is proposed that a co-travelling X-ray protection is provided behind the detectors viewed from the radiation source, for example a co-travelling concrete wall or an X-ray barrier of sand which co-travels in a container. The costs of constructing an X-ray screen on the other side of the large object to be scanned can therefore be reduced to the width of the stationary X-ray path, if necessary with a size allowance, for safety reasons. The construction costs can therefore be minimised, particularly in the case of long scanning distances, such as along a train.

According to a second aspect of the invention the object is achieved by an X-ray scanner for large objects such as containers, railway wagons or trucks, with at least one Radiation source and at least one detector between which rays are able to run along a ray path, and with a support for the large object, the radiation source and at least one of the detectors being connected to each other by means of a bridge and being displaceable on rails by means of their own drive.

Conceptually it may be explained in this regard that a “bridge” is understood to refer to a structure which runs beyond the space which is provided for the passage of the large objects to be scanned. The bridge will therefore extend from one side of the scanning space to the other side of the scanning space.

If the radiation source and the detectors are connected to each other by a stable bridge, and can be displaced without external force, as proposed, they are able to generate extremely accurate images. In particular, extremely small impermissible objects can also be detected in the large objects to be scanned since the ray path is guided extremely smoothly on rails because of the process. On the other hand, an unsupported Radiation source, as described in EP 1 635 169 A1, may be more easily caused to vibrate if the scanner is displaced as such. If both the radiation source and the detectors are supported on the road surface, as described in FR 2 808 088 A1, for example, the accuracy of the scanning results depends on the absolute flatness of the road surface. Although in a solution such as that disclosed in U.S. Pat. No. 6,928,141 B2 the scanner is displaceable on a rail, the detectors are mounted on conventional wheels. When the scanning gate in this solution is displaced, the accuracy of the images obtained is therefore dependent on the fact that the road surface runs underneath the detectors exactly parallel to the rail surface. A rail structure on both sides, on the other hand, can be constructed independently and with high precision.

Whenever the detectors and/or the radiation source, in particular, is or are guided on a rail, it is proposed that securing clips be provided which grip the rails. This can protect the system from outside influences such as earthquakes or hurricanes, and in particular the radiation source can be protected against damage.

If the radiation source lies on a rail it is proposed that it is arranged on a carriage which is mounted in a freestanding manner independently of a bridge. This is advantageous for safety reasons because the radiation source is in this manner retained particularly stably in its intended alignment or position.

If the radiation source is arranged in such a stably standing carriage, it is also proposed that the detectors be mounted on a bridge which is secured on the one hand to a stable carriage and on the other to an auxiliary carriage which is displaceably mounted on exactly one rail. This achieves, by simple means, a stable structure comprising the stable carriage with the radiation source, the bridge with the detectors and the auxiliary carriage. This saves the construction space required for the auxiliary space to be guided on exactly one rail.

If the auxiliary carriage runs on one rail over two wheels, an extremely stable guidance is guaranteed, resulting in accurate images.

An auxiliary carriage for supporting a bridge carrying the detectors is preferably not self-driven, which avoids control problems in matching the first drive with the auxiliary carriage drive. Costs and construction space are also saved.

According to a third aspect of the invention, the inventive object is achieved by an X-ray scanner for large objects such as containers, railway wagons or trucks, with at least one Radiation source and at least one detector between which rays are able to run along a ray path, and with a support for the large object, a protective space being provided for the operating personnel of the large object, preferably structurally integrated with the X-ray scanner.

When a large object is X-rayed rays necessarily also pass through the large object—with complete X-raying—where the operating personnel of the large object are located. For example, the driver's cab of a truck should, for safety reasons, be scanned by the scanning process just as the driver's cab of a railway train. In order to minimise the radiation load for the operating personnel of the large object, it is proposed that the protective space be located outside the scanning volume.

The scanning volume describes the volume in which the ray path is present, or which the ray path spans. Even in the case of very narrow detectors this is never a plane in the mathematical sense but at best only approximates to a plane. It is therefore a volume.

Since operating personnel of the object to be scanned need not generally have a detailed knowledge of the risks of radiation, it is advantage to provide a predestined protective space in which the operating personnel can remain during the scanning process. Although this reliably prevents the operating personnel from being outside the large object, they nevertheless pass through the scanning space.

If a protective space is provided it is proposed that this space and/or a service space for scanner service personnel be displaceable together with the radiation source and/or the detector. This facilitates not only the construction or dismantling of the X-ray scanner, but in particular the X-ray scanner service personnel are able to move together with the scanner during the scanning process. For example, if an uneven surface has to be passed over during the displacement movement as the scanning process progresses, the service personnel detect this by slight jerking in the service space. Here it may be advantageous, independently of the remaining features of this invention, to provide vibration sensors in generic X-ray scanners. Moreover, the optical perspective from the service space to the scanning volume always remains constant. Maintenance work can also be carried out on the radiation source and communication can then be made with the operating personnel without problem during the scanning process.

It is proposed, in particular, that the radiation source, the service space and the protective space be arranged together in a container that is displaceable on rails. This is a highly economic structure which also suffices with only one structural unit on the side of the radiation source.

If the protective space is displaceably designed it is proposed that a footbridge that is displaceable with the protective space be provided between the support and the protective space. Such a footbridge first increases comfort and safety for the operating personnel of the large object, and serves as an aid for the operating personnel of the large object to proceed to the protective space. At the same this also increases the safety of the scanner service personnel since it can be predicted very accurately where on the site the operating personnel will move.

According to a fourth aspect of the invention the inventive object is achieved by an X-ray scanner for large objects such as containers, railway wagons or trucks, particularly if a protective space is provided where a path for the operating personnel around the radiation source and through the protective space outside the ray path.

It can be seen immediately that such a path provided affords the same advantages as the provision of a footbridge, except that the route of the operating personnel through it can be predicted even more accurately. Because the path leads around the radiation source, better screening is also achieved than described in U.S. Pat. No. 6,542,580 B1, which screening enables the driver of a truck to pass by the side of a ray path.

Independently of this it is proposed, cumulatively or alternatively, that the radiation source of the X-ray scanner cannot be activated until the operating personnel are in the protective space. This not only excludes any risk to the operating personnel from radiation, but the operating personnel can also be easily kept in the protective space if an impermissible object is actually found in the large object to be scanned.

A safety space is preferably designed to be bullet proof, sort and/or impact proof. This provides the best possible protection for the service personnel.

According to a firth aspect of the invention the inventive object is achieved by an X-ray scanner for large objects such as containers, railway wagons or trucks, with at least one Radiation source and at least one detector between which rays are able to run along a ray path, and with a support for the large object when an independent current generator is provided. This also greatly simplifies assembly on a distant site, for example in a port. This also enables long distances from the radiation source to be covered.

According to a sixth aspect of the invention the inventive object is achieved by an X-ray scanner for large objects such as containers, railway wagons or trucks with at least one Radiation source and a multiplicity of detectors, where rays are able to run between the radiation source and the detectors along a ray path, and with a support for the large object, the detectors being arranged essentially along an arc, preferably along the arc of a circle. In particular, it is also proposed for this purpose that the detectors be displaceable perpendicularly to the ray path together with the radiation source.

The arrangement of the detectors in an arc around the radiation source results in a considerable increase in measuring accuracy compared to a linear arrangement, as is known conventionally. Silhouettes of the detectors against each other are also at least largely voided. Although the scanning system then requires a longer distance between the radiation source and the detectors, the rays are already weakened for this purpose in the case of the detectors to the extent that the entire arrangement of the system, including the radiation protection, need not generally be built any larger.

Ideally a true arc of a circle around the radiation source, along which arc the detectors are arranged and radially aligned. However, deviations are possible within the limits of the measuring accuracies to be achieved. It is essential that the detectors are not arranged along exclusively linear sections—as is conventionally known. For example, normal arrangements, such as those described in EP 1 635 169 A1 or U.S. Pat. No. 6,928,141 B1, lie in a strictly rectangular, U-shaped configuration. An arrangement such as that described in U.S. Pat. No. 6,843,599 B2, consists only of three linear sections of the detectors.

An arc-shaped arrangement can be achieved extremely simply by arranging the detectors on an arc-shaped frame, preferably on a frame in the shape of the arc of a circle. Such a frame provides not only a structural simplification but also, in a simple manner, high stability and hence high image accuracy.

In order to be able to design an arc structure extremely easily, it is proposed that the detectors are arranged in a plurality of rectilinear detector strips, the central perpendiculars of the detector strips each being aligned essentially to the radiation source, preferably with a deviation of less than 15°. It is self-evident that the more rectilinear detector strips are provided, and the shorter a detector strip, the closer the arc is approximated.

If the detectors are arranged in rectilinear detector strips, it is proposed that their centres are arranged essentially equidistantly from the radiation source. This enables the arc of a circle or at least a circle arc section to be approximated by simple means. For measuring accuracy deviations of below 5%, or preferably below 1%, are recommended relative to the distance from the detector surface to the radiation source surface.

According to a seventh aspect of the invention, the inventive object is achieved by an X-ray scanner for large objects such as containers, railway wagons or trucks, with at least one Radiation source and a multiplicity of detectors, in which rays are able to run between the radiation source and the detectors along a ray path, and with a support for the large object, means being provided for compensation for thermal expansion.

X-ray scanners of the type discussed here must be able to operate absolutely reliably in a wide variety of weather conditions. For example, the temperature may easily fluctuate between −40° C. at night in the winter and +80° C. in the day, with direct solar radiation, in the summer. Under all these conditions it should be guaranteed, if possible, that the mage obtained during scanning is not changed as a result of a geometrical displacement of the detectors. The compensation means should ensure this. The compensation means must therefore be characterised technically in that they convey to the detectors a movement of the suspension of the detectors only to a reduced degree, preferably as little as possible. Numerous more or less complicated designs are suitable for this purpose.

The compensation means preferably comprise detector rails which are provided on a frame and on which the detectors are displaceably arranged, spring means preferably being provided which act on the detectors parallel to the detector rails. Merely the provision of the detectors on the detector rails on a frame results in more uniform displacement of the detectors. Moreover, if springs are connected to the detectors parallel to the rails, they further reduce an expansion of the frame on which the springs are anchored correspondingly.

If the frame is then rigidly connected to the radiation source, the geometry remains as uniform as possible even in major fluctuations in weather conditions.

It has already been pointed out that the compensation means may be mounted on a frame, in which case the detectors are preferably arranged in detector strips. This facilitates the construction of the entire detector system. In particular, the individual detectors need not be each connected to compensation means but good results are already achieved if only one detector strip is connected by one compensation means to the frame.

It is proposed that the compensation means have temperature-stable spacers, for example a housing of the detector strips. This ensures that the detectors are only displaced a short distance, even if the frame is highly loaded. Conceptually it should also be explained that although a single-piece spacer is strictly speaking always temperature-unstable, such an element may have a considerably lower thermal expansion than the frame, even if designed in one piece, for example it has a coefficient of thermal expansion which is lower by at least a power of ten than the effective coefficient of thermal expansion of the frame.

The compensation means preferably comprise a thermally insulating housing for the detectors or detector strips. Provision my be made, in particular, for a thermal insulation layer to be provided inside an outer envelope of a housing, which layer has a much lower density than the housing material itself, for example at least a density a power of ten, in particular three powers of ten, lower than the density of the housing material. For example, the housing may be formed from a steel sheet or a hard plastic, whilst heat insulating foam is provided on the inside of the housing. Advantageously any spacers provided need not be as individually stabilised to counter possible temperature fluctuations as if no housing were provided. The housing also offers the detectors protection against other environmental influences.

According to an eighth aspect of the invention, the inventive object is achieved by an X-ray scanner for large objects such as containers, railway wagons or trucks, with at least one Radiation source and a multiplicity of detectors, in which rays are able to run between the radiation source and the detectors along a ray path, and with a support for the large object, a common housing being provided for the detectors or detector strips in which all the detectors are arranged.

Such a one-piece housing protects the sensitive detectors and any mechanical elements from environmental influences, the very design as a single-piece housing greatly simplifying the climatisation of the detectors. According to the state art, as described for example in FR 2 808 088 A1 or U.S. Pat. No. 6,843,599 B2, joints separating the detector housings are fitted between a plurality of detector housings. Such a structure renders any climatisation provided less effective.

It has already been mentioned that the housing may comprise thermal insulation.

It is advantageous for the interior of the housing to be climatised, in particular actively climatised. Passive climatisation can already be provided by allowing the heated air inside the housing to escape to the outside, drawing in cooler air. Cooling ribs and/or vents, for example, may be provided at suitable points in the housing for this purpose. Extremely good results with regard to climatisation, and hence also with regard to the service life and result accuracy of the scanner, are obtained when active climatisation is provided. Active climatisation is characterised in that it is capable and is set up, by means of a fan, to feed air cooler than that present in the housing interior into the latter and in doing so to displace the warmer air present there.

It is self-evident that a continuous housing for the detectors may be installed on a frame.

According to a ninth aspect of the invention, the inventive object is achieved by an X-ray scanner for large objects such as containers, railway wagons or trucks, with at least one Radiation source and a multiplicity of detectors, in which rays are able to run between the radiation source and the detectors along a ray path, and with a support for the large object, a frame, which is connected essentially rigidly to the radiation source, being provided for the detectors.

This enables measuring inaccuracies to be reduced to a minimum because the frame is automatically carried along with each movement of the radiation source. In particular, no hydraulic feed-in capacity will be provided on the frame or the like for performing movements. A frame may be considered to be rigid, in the sense of what is stated above, when it is completely free from such components. If such components are provided, a corresponding frame must be regarded as rigid when it has fixing means, such as bolts or the like, which establish moving regions in such a manner that any remaining residual movements are smaller than the size of the natural vibrations of the entire frame.

It is self-evident that such a rigid connection is advantageous, particularly for axially moving Radiation sources which are displaced along the large object.

If thermal compensation is provided, it is advantageous for the frame to be rigidly connected to the radiation source except for the thermal compensation. This achieves a good compromise between a rigid frame with these advantages and the thermal compensation which increases measuring accuracy by other means.

It is self-evident that a rigid frame or a frame that is rigid apart from thermal compensation may serve as a connection by means of thermal compensation for the detectors. As soon as the detectors have thermal compensation and are otherwise rigidly connected to the frame, exactly the same advantageous compromise is found here as described above for connection of the frame to the radiation source.

In the case of a particularly rigid frame connecting the detectors to the radiation source, it is proposed that the detectors and the radiation source can be displaced linearly along a path relative to the large object, and that the frame is arranged horizontally inclined by an angle smaller or larger than 90° to the path. The advantage of this arrangement is that transverse walls of the large object, such as front walls, need not be X-rayed parallel to the wall but may be X-rayed transversely to it. There is therefore no shading line in the silhouette, which enables even very small objects to be more easily detected.

It should be pointed out that it is irrelevant here whether the large object or the radiation source and the detectors are moved to achieve the displaceability of the scanning unit relative to the large object. Instead all that matters is the relative movement between the scanner and the large object.

According to a tenth aspect of the invention, the inventive object is achieved by an X-ray scanner for large objects such as containers, railway wagons or trucks, with at least one Radiation source and a multiplicity of detectors, in which rays are able to run between the radiation source and the detectors along a ray path, and with a support for the large object, the ray path being horizontally inclined by an angle not equal to 90°, i.e. smaller or greater than 90°, relative to the path along which the detectors and the radiation source can be displaced relative to the large object. This has already been explained above, but it is also advantageous and inventive independently of all the other aspects mentioned.

A simple, stable structure of the scanner is also obtained in the case of a horizontally inclined frame and ray path if the ray path is arranged in the vertical plane.

According to an eleventh aspect of the invention, the inventive object is achieved by an X-ray scanner for large objects such as containers, railway wagons or trucks, with at least one radiation source and a multiplicity of detectors, in which rays are able to run between the radiation source and the detectors along a ray path, and with a support for the large object, the radiation source being arranged in a standard container, preferably in a 40 foot container or in a 20 foot container.

This aspect allows simple transport and simple assembly of the entire arrangement, particularly also from overseas.

A service space for service personnel of the X-ray scanner and/or a protective space for operating personnel of the large object, for example a truck driver or locomotive driver, are preferably arranged in the container. These aspects have already been explained in a different context.

It is proposed that the container can be run on rails. Specifically means should therefore be provided for forward movement of the container on rails on it. This allows not only simple displaceability in the scanning application, but also transport of the scanning unit without problem to a site of application on the rails of a railway network.

In a container for the X-ray scanner the radiation source should preferably be arranged in a separate space. Only this separate arrangement helps avoid radiation damage to the scanner service personnel.

It is also proposed that the separate space for the radiation source be specially screened for the ray path except for an outlet gap. Alternatively and cumulatively the radiation source itself can be screened for the ray path except for an outlet gap. Both further increase the radiation safety of the system as a whole.

According to a twelfth aspect of the invention, the inventive object is achieved by an X-ray scanner for large objects such as containers, railway wagons or trucks, with at least one Radiation source and a multiplicity of detectors, in which rays are able to run between the radiation source and the detectors along a ray path, and with a support for the large object, the radiation source being screened, bundled and/or directed so that at the level of the detector or at the level of at least one detector strip the ray width is no more than twice as wide as the detector or detector strip.

If the system is designed so that the scanning volume is limited to such a narrow ray strip on the detector, the screening on the other side of the detectors may be reduced to a minimum, which helps save construction costs and construction volume.

Here too it is advantageous, as explained above, for the radiation source and the detector to be movably arranged and for a co-travelling radiation protection, e.g. a co-travelling concrete wall, to be provided behind the detector, viewed from the radiation source. Such a structure is particularly for scanning long large objects such as trains, particularly since the scanner can then also travel on tracks.

Alternatively and cumulatively it is proposed that the radiation source and the detector are movably arranged and that a fixed radiation protection, for example a fixed concrete wall, is provided behind the detector, viewed from the radiation source. This enables the radiation to be further increased.

The radiation source may, in particular, be an X-ray source, a gamma ray source and/or a neutron source.

It is self-evident that for safety reasons only the ray should be as narrow as possible. For this reason it is proposed that the ray path passes through a series collimator. In this context the term “series collimator” refers to an arrangement of at least two partial collimators limiting a ray path, which collimators are connected to each other by a common radiation damping wall aligned essentially parallel to the main ray path, and extend from this wall into the ray path. Such an arrangement allows extraordinarily good focussing of the ray path, because on the one hand any reflections on surfaces which are aligned parallel to the ray path into the ray path can be minimised by minimising these surfaces, and because on the other hand the partial collimators have surface regions directed perpendicularly to the ray path, which regions are naturally able to absorb rays very well.

Preferably at least 5 or 8 partial collimators should be arranged one behind the other, in particular on both sides of the ray path, it being self-evident that such partial collimators should only be provided where suitable limitation of the ray path is also required.

Cumulatively or alternatively to this it is proposed that the ray path passes by at least one ray trap. In this context a ray trap refers to a recess aligned essentially perpendicularly to the ray path, with a radiation damping wall. If a ray path passes by such a recess and if rays enter the recess, such rays for the most part stop moving until they leave the recess again. They are therefore caught in the ray trap.

If a series collimator is suitably designed, it correspondingly has one or a plurality of ray traps.

Preferably the series collimator and/or the ray trap are arranged in the ray path behind a source collimator. Because of the risk emanating from them, Radiation sources are already intensively screened in their immediate surroundings, a suitable source collimator ensuring that the rays can only leave the radiation source within a specific spatial region. In this case, however, the source collimator is not able to parallelise this region sufficiently, particularly in the case of long ray paths. Helpful here are the series collimator and/or the ray trap, which can also considerably increase, by simple structural means, the operating reliability of X-ray scanners for large objects with at least one radiation source and at least one detector between which rays are able to run along a ray path, independently of all the other features of this invention.

In particular, the series collimator or the X-ray trap can connect directly to the source collimator so that optimum use can be made of the corresponding advantages in the shortest construction space.

The at least one detector can be arranged on a logic-free detector module which is connected releasably to a support. A detector can therefore be replaced easily and at low cost if it is defective, in particular without corresponding measuring electronics, required for sensorics comprising the detector, also having to be replaced. Such an approach is also advantageous independently of all the features for detectors of radiation that is more energy rich than visible light, particularly UV light, since such detectors are highly exposed to this energy-rich radiation for reasons of sensitivity, and age correspondingly quickly.

The detector module is also preferably designed electronics-free. Electronic components, such as operational amplifiers, capacitors or coils, are also installed outside a radiation load in such arrangements, if possible, and generally age less quickly than the connected detectors. To this extent the costs are therefore minimised when a detector is replaced.

In addition, such a passive detector module enables the detectors to be replaced very easily with suitable design of the overall arrangement, since logical or electronic components in such detector arrangements are generally placed not only outside a ray path, if possible, but also behind a screen in order to avoid disturbances. However, the detectors are not screened because they will of course also be detecting the rays. To this extent the detectors can be removed or replaced in such an arrangement past the screen from the direction of the X-ray path so that this can be carried out very easily.

A replacement, particularly past a screen, can be carried out particularly easily if the connection of the detector module to its support is a plug-in connection. The plug-in connection is preferably designed so that it is electrically conducting so that the electrical connection between the detector and the remaining sensorics can be opened or closed in the plugging process.

In order to minimise the costs of a detector replacement, the detector module has no more than 32 detectors, preferably no more than 16 detectors. This also enables a plurality of detector modules to be arranged adjacent to each other at an angle so that a curve radius or a circular path can be followed with such modules without the deviations being too great despite modules that are designed rectilinearly or essentially flat.

The support of the detector module may be a logic-free intermediate support which is arranged on a main support with measuring electronics. Only amplifiers, i.e. only operational amplifiers, for example, which are already designed, in particular, as integrators, are preferably arranged on the intermediate support. Such a logic-free intermediate support allows a particularly compact structure of the amplifiers or other non-logical assemblies in relating to the detectors on the one hand, so that distances between the detectors and amplifiers can be minimised. This also minimises faults. The same applies to the electrical distance between purely electrical assemblies and logic assemblies which can therefore be minimised in a suitable design.

The at least one detector is preferably arranged on a module unit with no more than 32 detectors, preferably even with no more than 16 detectors. As already indicated above, such small module units allow an extremely flexible construction, particularly if the entire detector unit is not of a rectilinear construction but is to have a curved course. Module units too long would the result in relatively large deviations from the ideal. Here this module unit is connected to at least one further module unit by means of a bus connection, and/or is movably mounted on at least one further module unit. Whilst the former guarantees a very simple overall structure and very simple replacement of individual module units, the latter makes it easier to arrange the module units adjacent to each other in a curved overall arrangement. Here it is self-evident that both these designs also have cumulatively or alternatively the corresponding advantages independently of all the other features of this invention.

A measuring device and/or a correction device for measuring or correcting a vertical displacement of the frame and Radiation source relative to the large object or relative to the support are preferably provided so that any differences that arise during a relative displacement between the radiation source and detectors on the one hand and the major object on the other can be reliably detected and falsifications of the image generated can be avoided. The correction preferably takes before commencement of the actual image generation, so that on the one hand image generating devices can be used by a known method and on the other the correction can be made quickly and reliably. It is self-evident that such measuring devices or correction devices are also of corresponding advantage for X-ray scanners of large objects independently of all the other features of this invention.

The invention is explained in greater detail in the following on the basis of two exemplary embodiments with reference to the drawing. Functionally similar or identical components may have identical reference numbers.

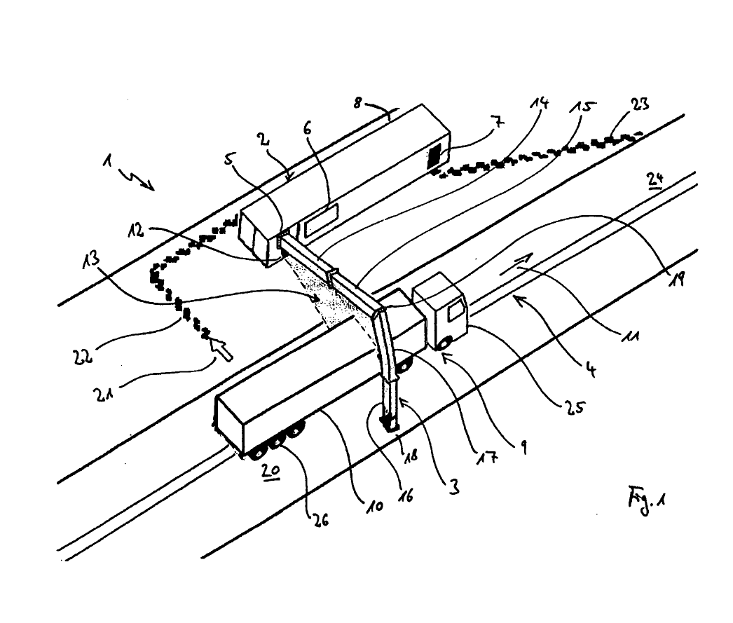

FIG. 1 shows, in a perspective view, an exemplary embodiment for an X-ray system having a stationary construction;

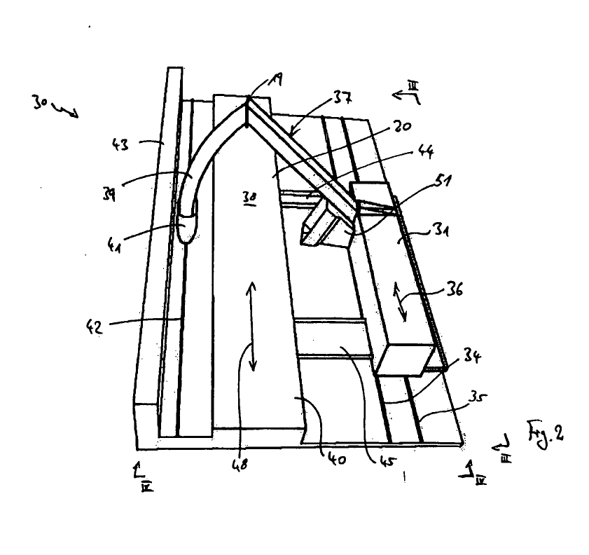

FIG. 2 shows, in a perspective view, an exemplary embodiment of a displaceable X-ray system;

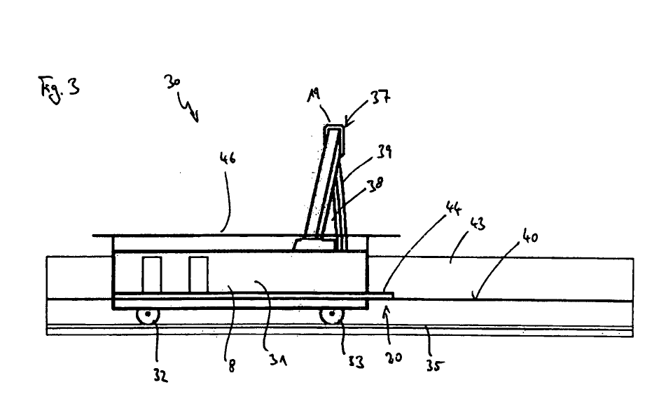

FIG. 3 shows the system in FIG. 2 in a view according to marking III-III;

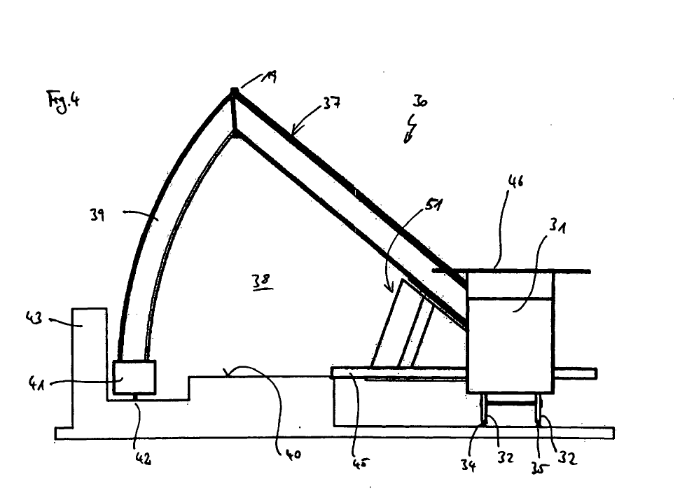

FIG. 4 shows the system in FIGS. 2 and 3 according to marking IV-IV;

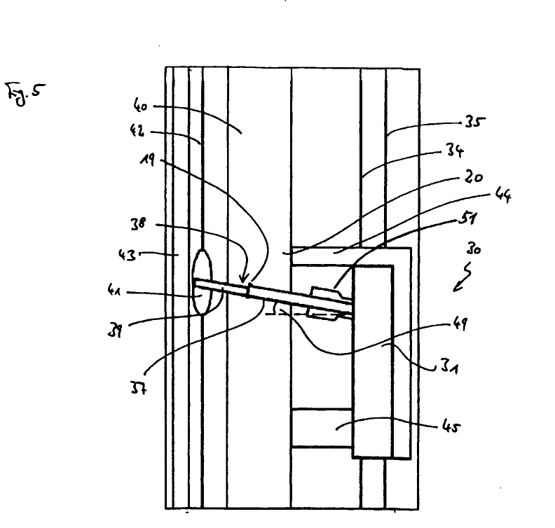

FIG. 5 shows the systems in FIGS. 2 to 4 in an elevation;

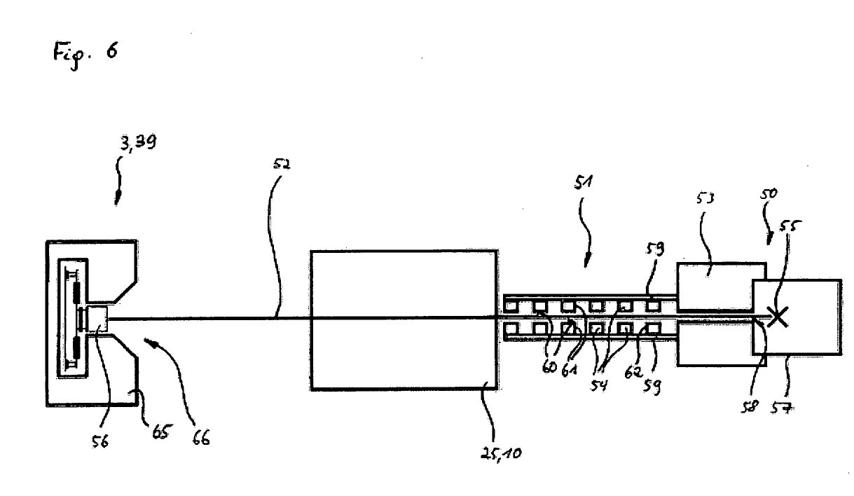

FIG. 6 shows a diagrammatic cross-section through the ray path;

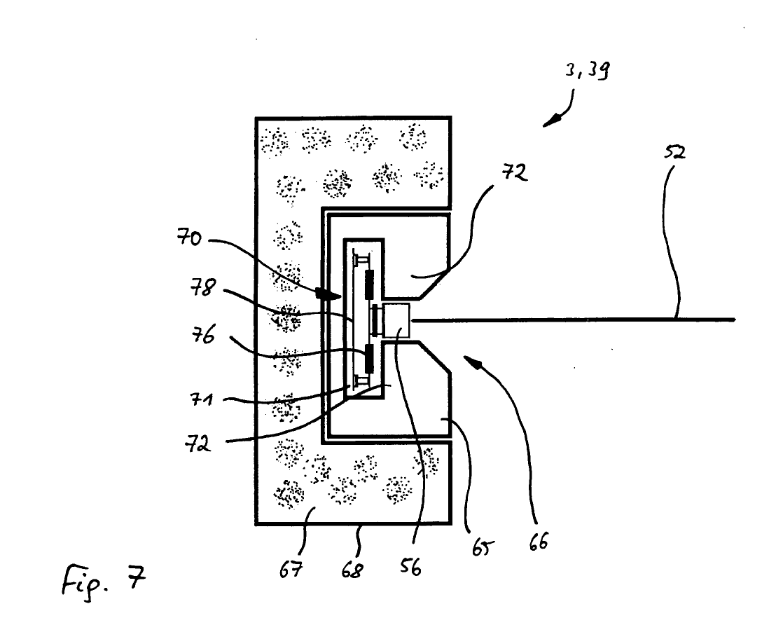

FIG. 7 shows a detailed enlargement of the detector unit in FIG. 6;

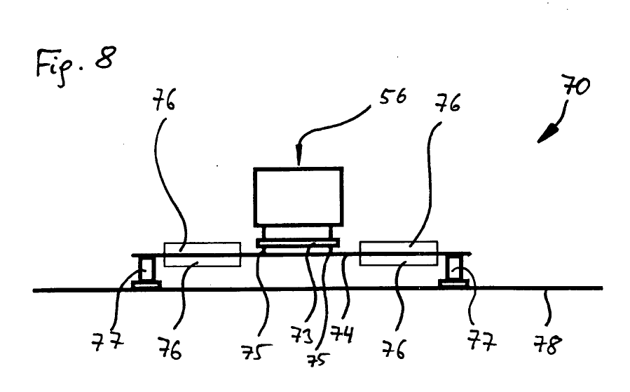

FIG. 8 shows the detector unit in FIG. 7;

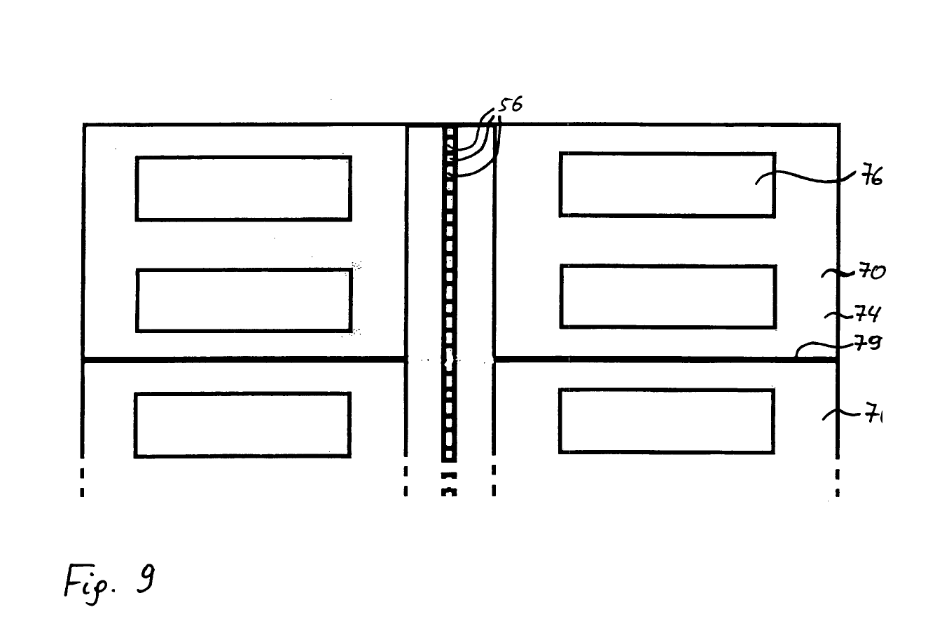

FIG. 9 shows an elevation of the detector unit in FIGS. 7 and 8;

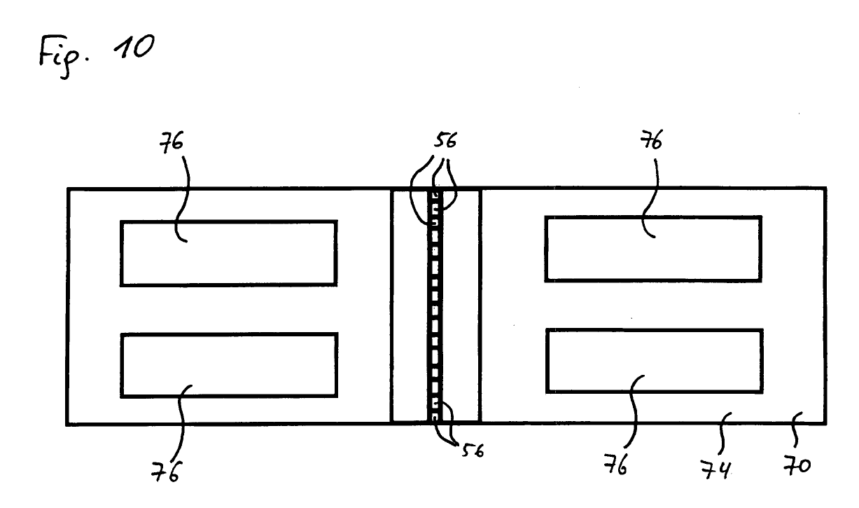

FIG. 10 shows an individual detector unit in FIG. 9;

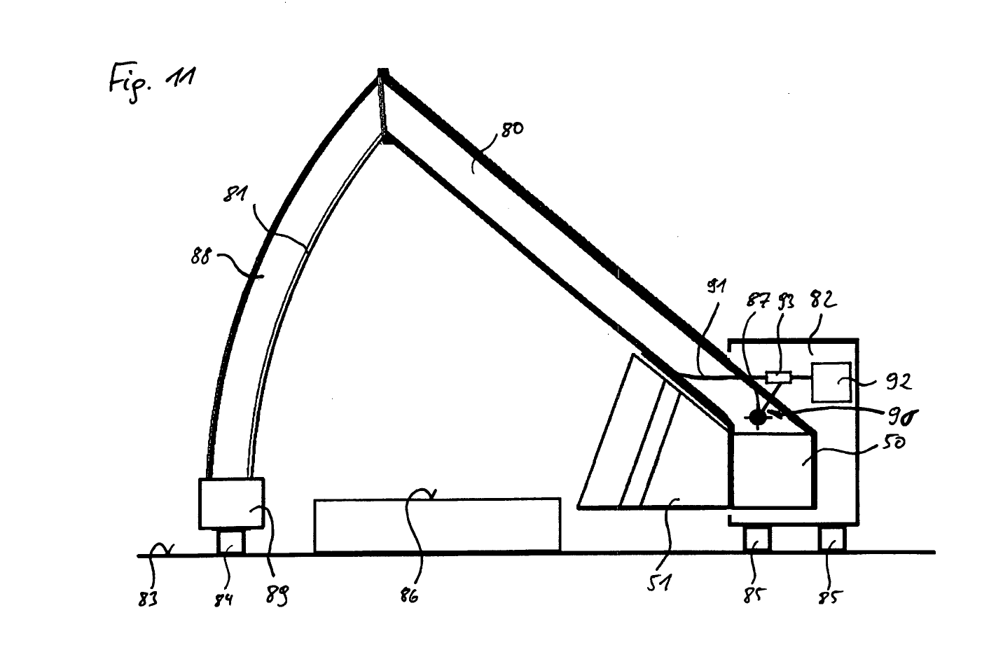

FIG. 11 shows, in a perspective view, a further exemplary embodiment of a displaceable X-ray system;

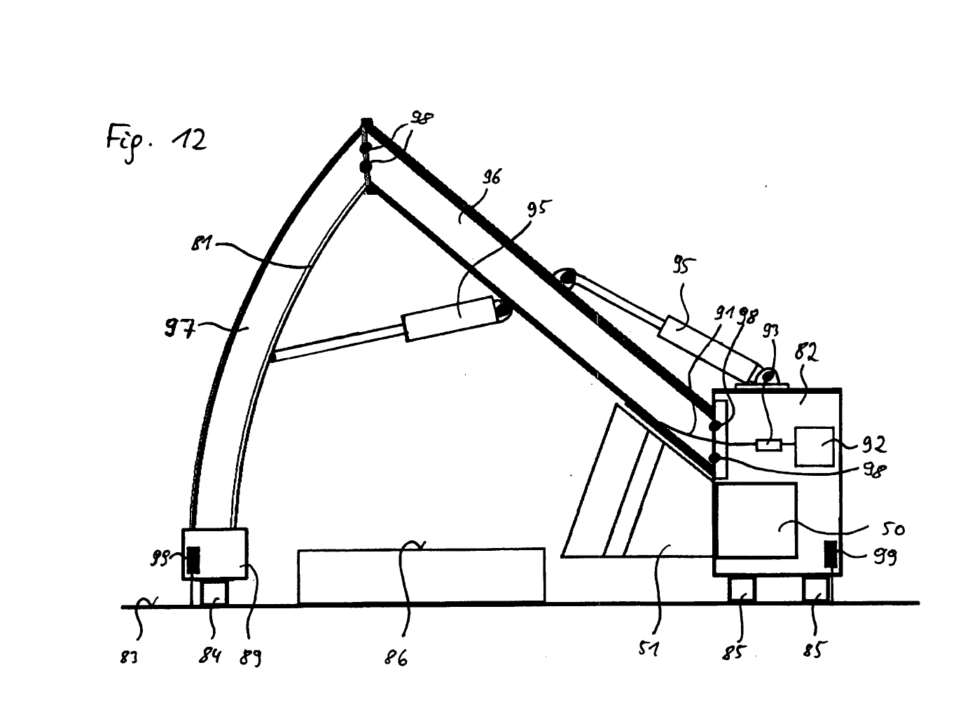

FIG. 12 shows, in a perspective view, a further exemplary embodiment of a displaceable X-ray system; and

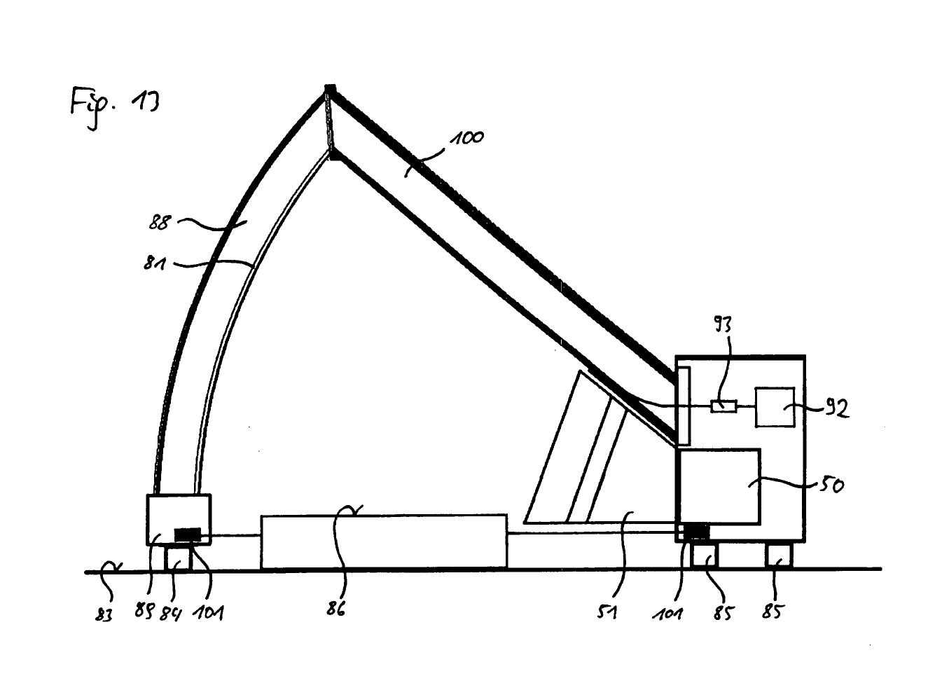

FIG. 13 shows, in a perspective view, a further exemplary embodiment of a displaceable X-ray system.

X-ray system 1 in FIG. 1 consists essentially of a stationarily constructed container 2, a partially arc-shaped frame 3 connected to it and a conveyor belt 4.

A plurality of spaces is formed in container 2, namely initially an inspection or service space for service personnel operating X-ray station 1. Furthermore, a space is formed for an X-ray radiation source. Finally, a separating cell is provided. The space for the X-ray source is located immediately below a connection 5 of housing frame 3 on container 2. The inspection space for the service personnel is located behind a large inspection window 6 in container 2 directed toward conveyor belt 4. The separating cell is located behind an exit door 7 on the conveyor belt side and has an entrance door on a side 8 of container 2 facing away from the conveyor belt.

Conveyor belt 4 is set up to convey any large objects, such as trucks 9, with a loaded transport container 10, into a conveyor device 11 through arc 3, linearly forwards. From an X-ray output 12 on the container the radiation source emits X-ray radiation through a relatively two-dimensional scanning space 13, which fans out towards bridge arc 3 and finally represents the ray path. Bridge arc 3 consists essentially of two horizontal ridge sections 14, 15 connected to each other, a base 16 and a detector region 17 in the shape of an arc section. Detectors for the X-ray radiation which is emitted at X-ray output 12 are located inside base section 16 and detector section 17 in the shape of an arc section, and according to geometric conditions, also at least in one section 15 of the two bridge sections 14, 15. Here the four parts 14, 15, 16, 17 of bridge 3 are screwed rigidly together, to a foundation 18 and, at connection 5, to container 2 by means of connection flanges (denoted by 19, for example).

In this case the two bridge parts 14, 15 lead from container connection 5 relative to the horizontal upwards as far as the highest point on connection flange 19. Arc 17, which is then connected, is formed so that it follows at least essentially the arc of a circle which has its centre at the X-ray emitter. Base section 16 of frame 3 is installed slightly inclined relative to the perpendicular so that its central perpendicular is directed towards the X-ray emitter.

When truck 9 is to be scanned for impermissible contents by X-ray, when system 1 is in operation, the driver of truck 9 drives it as far as an exit position 20, which is still located in front of scanning space 13 relative to direction of conveying 11. He leaves truck 9 in an exit direction 21 and follows a path 22 around container 2 and the radiation source as far as the entrance door on side 8 facing away from the conveyor belt, and enters the separating space through this door. The operating personnel of X-ray system 1 have means of communication with the separating space inside container 2. In the simplest cases these means may simply have an inspection window and/or an intercom system and/or a document push-through. The operating personnel of system 1 my therefore detect simply and reliably that the driver of truck 9 is now located in the separating space.

The separating space is then remotely locked by the service personnel of system 1 so that the driver of truck 9 cannot easily leave the separating room. The service personnel then activate the X-ray emitter and therefore create scanning space 13.

The detectors arranged in parts 16 and 17 of bridge 3 (not shown) receive a shadow-free image of the X-ray radiation and transmit it via cabling running in housing parts 14, 15, 16, 17 to container 2. In the service space these data are processed electronically and displayed to the service personnel of system 1 optically and/or analysed by a microprocessor. The service personnel then activate conveyor belt 4 in conveying direction 11 and in this manner drive the entire truck 9 through scanning space 13. Throughout the time the silhouette is detected by the detectors and transmitted to the service personnel.

If there is no indication of impermissible objects during X-raying, the service personnel open exit door 7 and therefore open up an entrance path 23. This creates an entrance position 24 on conveyor belt 4, on which truck 9 and, in particular, its driver's cab 25 are located when the entire truck 9 has passed through scanning space 13.

If suspicious silhouettes appear the service personnel of system 1 can also activate conveyor belt 4 against the main direction of movement 11, and therefore drive truck 9 back to the suspicious point. Alternatively and cumulatively it is also possible to re-examine the entire scanning process by means of EDP-stored images.

System 1 therefore enables a complete image of the entire truck 9 to be received, including driver's cab 25, the conveyed container 10 and all wheels (denoted by 26, for example) of the truck. Here the arc-shaped section 17 enables the best possible silhouette to be generated without any invisible region.

System 1 also has equipment (not shown here) for photographing, storing and archiving vehicle 25 and container 10. Here both the container numbers and the registration numbers of tractor 25 can be automatically recognised and also archived.

A complete infrastructure for the service personnel is provided in the service space in container 2 so that the service personnel need not necessarily leave the service space.

Frame 14, 15, 16, 17 is provided with a robust steel housing, and the entire system has a concrete foundation. The system is therefore of a very stable construction. It is provided with weather protection so that it is able to operate independently. Paths 21, 22, 23 and generally the entire system are provided with lighting so that the system can also operate at night without problem.

The service space in container 2 is equipped with an industrial computer which requires a special login by the service personnel. The images and all the data obtained are stored and backed up automatically, a coding algorithm being optionally provided. A large colour screen is provided for the service personnel for inputting data and examining the scanned images. A colour laser printer is also installed. The lighting in the service space is provided with an emergency unit, as well as with an air-conditioning system. The entrance and exit doors to the service space have a biometric recognition system, for example based on iris recognition and/or fingerprint recognition. Both the communication window for the separating room and observation window 6 can be covered and locked from the outside within the shortest possible time for protecting the service personnel.

A further contribution to radiation protection is the fact that the entire X-ray system is continuously monitored by a computer. In the case of a fault the X-ray automatically switches off. Moreover, the X-ray radiation can be terminated manually within the shortest possible time by means of a switch. At the same time warning lights light up in the region of scanning space 13 whenever the radiation source is activated. To ensure that a person does not accidentally enter scanning space 13, infrared sensors are provided which are able to detect such entry in good time and switch off the X-ray source. Surveillance cameras are also installed everywhere on system 1.

Impermissible goods are automatically colour marked for the service personnel in container 2, the service personnel being given the opportunity to enlarge the graphic representation to any scale. It is also possible to switch between a negative and positive representation of the image. Various other digital image filters may also be added.

The resolution of the X-ray image is approximately 10 mm in the central region of the freight to be inspected. Here the radiation is set so high that up to 300 mm of steel can be penetrated. According to estimates 25,000 or more large objects can be scanned in the course of a calendar year without problem.

The X-ray source has an output of 8 MeV. In this case conveyor belt 4 is set so that at a length of at least 20 m can be traveled through scanning space 13. Bridge 3 makes space for a height of X-ray space 13 of over 4 m. Conveyor belt 14 also permits a width of at least 3 m for the large object to be scanned. The lowest scanning ray runs exactly on the surface of conveyor belt 14.

In detail a plurality of detectors are each arranged on a straight detector strip inside the arc-shaped section 17. The detector strips themselves are then aligned inside the housing of arc-shaped section 17 so that their central perpendiculars are directed towards the X-ray source. The individual detector strips are located in a rail inside housing 17. They are not connected punctually to the rail system but are compressed by spring resilience on one side or on both sides. This means that even during thermal expansion of housing 17 the detector strips are still compressed between the springs without a gap forming between the individual detector strips.

A support with two stabilising rolls can also be provided advantageously on connection 18 of arc 3 to the foundation. Bridge 3 is rigidly connected to container 2 so that stresses may form during a thermal expansion. If the arc is mounted on support 18 on rolls, these stresses are reduced. Nevertheless arc 3 also completes each movement of the radiation source, for example if the floor sinks slightly.

Here the course of bridge 3 is not exactly perpendicular to conveying direction 11 relative to all four parts 14, 15, 16, 17, but deviates by approximately 8° from this direction. The advantage of this is that the front faces of the load can be X-rayed at an inclined angle.

Structurally only filtered air is supplied to the service space in order to increase further the safety of the service personnel. Moreover, a second roof is provided over container 2 above the radiation source housing in order to prevent solar radiation from penetrating the radiation source housing.

The second system 30 in FIGS. 2 to 5 again consists essentially of a container 31 with an Radiation source emitter, service space and separating space. Unlike in the stationary design shown in FIG. 1, however, the station in FIGS. 2 to 6 are displaceable in design and for this purpose are mounted on two rails 34, 35 by means of wheels 32, 33. Container 31 can therefore be displaced along a displacing device 36 with little resistance and in a highly uniform manner.

The radiation source radiates by means of collimators 51 underneath a bridge 37 through a scanning space 38 as far as a large arc-shaped frame section 39 which runs equidistantly around the radiation source from a highest point 19 to the height of a conveyor platform 40. Platform 40 is higher than the radiation source and the lowest detectors (not shown) in arc-shaped section 39 relative to the vertical.

Arc 39 leads to a support carriage 41 which is mounted by means of two wheels (not shown) on a simple rail 42. In this exemplary embodiment a stationary radiation protection wall 43 is constructed on the other side of arc 39 and auxiliary carriage 41.

From an exit position 20 on platform 40 a gangway 44 leads around container 31 to the entrance of the separating space. From the exit of the separating space a second gangway 45 leads back to platform 40.

A second roof 46 is provided above container 31 to protect against direct solar radiation. This roof projects laterally from container 31 so that protection from solar radiation at a slightly inclined angle is also provided.

Gangway bridges 44, 45 lie on the platform but are connected to container 31 so that the entire structure, comprising container 31, gangways 44, 45, the radiation source with collimator 51 as well as bridge 37, detection arc 39 and auxiliary carriage 41, moves in direction of movement 36 as one unit along displacement device 36 when container 31 is displaced. Here bridge 37 is rotated at an angle 49 of approximately 10° in the horizontal relative to displacement device 36 and hence also relative to a main extension direction 48 of platform 40.

The load or track (not shown) to be scanned is located by means of platform 40 on a higher horizontal plane than the lowest X-ray course in scanning space 38 so that the large object to be scanned is fully X-rayed. Here the X-ray is bundled horizontally to the extent that it attains a maximum of twice the width of detector strip 39. Alternatively or cumulatively to fixed radiation protection wall 43, a co-travelling X-ray protection wall may also be provided.

At the beginning of an X-ray scan the system moves fully automatically, returns automatically to the initial position and automatically sets its speed of travel. Generally only one person is required to operate system 30. The data are transferred automatically to the image processing system.

In this case the software ensures that data are received from the detector strips and imported into images. There the software calculates distortions automatically and sets the false colour filter and contrast filter.

In order to be able to assign clearly as many objects that can be scanned by X-ray, the software automatically sets contour recognition filters. Numerous contours, complete or in parts, are stored in a database.

Moreover, the software sets automatic material recognition filters. The material signals are also stored in parts or completely in a database.

All images of the detectors scanned are stored in a database together with identification numbers of the individual scanning processes and time stamps. All the results of the image processing software, with identification numbers and time stamps, are also recorded in the database. The data on the operating service person and any other persons responsible for deciding whether a large object to be scanned is complained of or not are also scanned for each scanning. For this purpose all the service personnel must identify themselves clearly before activating the image processing software.

The system also has software which takes over the complete movement control of the system. The identifying data on the freight and/or truck are in this case received optically by the software and automatically detected. These data are also stored with identification numbers and time stamps in the database. If radio data carriers are present in the freight or on the truck, either actively or passively in the form of transponders, the software may also receive three and also store them in the database.

If possible biometric data on the truck drivers or the remaining personnel operating the large objects, are also received, for example iris images or fingerprint data. These data are also stored in the database if this is permissible according to the Data Protection Act. The software can receive optically, automatically recognise the data from identification data and also store them in the database. If the identification documents are suitably equipped, the software is also able to read in personal identification data and/or passport data and/or other identification data by radio.

The personal and/or biometric data of the personnel operating the large objects to be scanned and/or freight data may be stored in a databank, thus enabling the software to match such data. If the data do not match and/or if there is a risk to the operating personnel and/or if a potentially impermissible object is discovered in the large object to be scanned, the software emits a warning. Optionally the personnel operating the large object to be scanned are automatically protected in the separating space until security personnel and/or a representative of the executive arrive.

The scanning parameters can, moreover, be automatically set by the software on the basis of the freight to be scanned, recognisable for example by the freight documents. Furthermore, the software may be able to move the scanning system to critical points of the load and there travel along the object again at a slower speed, for example.

It should be expressly pointed out that all aspects of this invention can be advantageously used both on rail systems and on roller or tyre systems, and also statically.

Considerable safety advantages can generally be achieved with the invention presented.

As represented diagrammatically in FIG. 6, scanning spaces 13, 38, in which can be found truck 25 or container 10, for example, are roamed by a principal ray 52, which reaches detectors from a radiation source 50, which detectors are arranged in frame 3, 39. In this case radiation source 50 comprises an actual starting point 55 for the radiation which is arranged inside a screen 57 which the ray path, and in particular also principal ray 52, is able to leave through an opening 58, radiation source 50 having, furthermore, a source collimator 53 which is arranged around opening 58 and is intended to prevent scattered radiation. Such radiation sources 50 are sufficiently known in themselves from the state of the art and are easily obtainable in this design. In the exemplary embodiments proposed series collimators 51 are connected directly to source collimator 53, which collimators also limit the ray path so that in the case of very long distances it does now widen too much. In this case series collimators 51 comprise partial collimators 54 which are connected to each other by means of a common wall 59. These walls 59 are aligned essentially parallel to main ray path 52.

Both partial collimators 54 and walls 59 comprise materials which have a radiation damping effect. For example, they may be formed from lead and/or filled with radiation damping sand.

Even a direct comparison with source collimator 53 shows that such a series collimator 51 has far fewer surface components 60 limiting the ray path, with the same overall length parallel to the ray path. The proportion of rays which reflects on these surfaces 60 or corresponding inner structures and is not therefore suitably screened can be reduced in this manner. Rays which indeed also touch source collimator 53 at an angle, but do not touch surfaces 60 of the partial collimators aligned to the ray path, can then be screened by walls 61 of the partial collimators aligned essentially perpendicularly to the ray path.

In addition walls 61 and 62 of the partial collimators and radiation damping wall 59 of series collimators 51 form ray traps which it is difficult for rays to leave again if they ever reach it. This applies particularly to rays which want to leave the ray traps parallel to main ray path 52.

As can be seen in FIG. 6, detectors 56, which are here formed from individual scintillator crystals with associated light-sensitive diodes, are exposed directly to the ray path in this exemplary embodiment, and are surrounded by a lead screen 65 with a slotted opening 66. A screen 67 of screening sand is also provided on the side of lead screen 66 facing away from ray path, as shown in FIG. 7. For this purpose the frame or frame 3, 39 is suitably designed as a hollow frame and has a wall 68 which in this exemplary embodiment represents essentially the shape of an encircled U. This U encloses lead screen 65 on the side facing away from the ray path. Here it is self-evident that such a hollow body filled with screening sand is also advantageous independently of all the other features of this invention.

Detectors 56 are arranged on detector modules 70, which are mounted in a T-shaped recess 71 of the lead screen, which leads to a situation where lead screen 65 has regions 72 projecting from detector modules 70 on the side of gap 66, which regions largely protect detector modules 70 from radiation. Because of T-shaped recess 71, whose central beam ultimately represents gap 66, detectors 56 can on the other hand be exposed without difficulty in the direction of radiation source 50. In this case it is self-evident that a protective, but largely radiation permeable cover can be provided in front of the detectors in an alternative embodiment.

The detector modules are directly guided and retained by the lead screen, according to the specific embodiment, and a separate guide may be provided inside the screen for the detector modules in an alternative embodiment. In such an embodiment the modules can easily be displaced along recess 71 (perpendicularly to the drawing plane in FIGS. 6 to 8) inside recess 71 so that they are easily able to follow a curved shape or a similar curvature of the frame structure or frame 3, 39. The same applies in particular when the individual modules are arranged movably adjacent to one another—and are, for example, only connected to each other by a cable connection or the like. Here it is self-evident that such guidance of detector modules inside a screen is also advantageous independently of all the other features of this invention.

The individual detector modules are connected to each other by means of a bus connection, for example an Ethernet bus, a serial bus connection or optical fibre connection, so that information can be transmitted serially along the individual detector modules and can be read out easily at the end of the entire detector unit.

In this exemplary embodiment detectors 56 are installed directly on standard bases 73 which can in turn be plugged into suitable standard plug-in connections on an intermediate carrier plate 74. In this exemplary embodiment any electronic or logical assemblies between standard bases 73 and detectors 56 are dispensed with. The measuring signals of detectors 56 therefore run directly from detectors 56 via plug-in contacts 75, which are formed by base strips 73 and the standard plugs, to intermediate plate 74, where they are fed directly to operating amplifiers 76 designed as integrators. These integrators therefore represent the first electronic components to which signals are transmitted from detectors 56. In this exemplary embodiment conventional integrators are used which each consist of suitably switched operating amplifier pairs so that each integrator 76 is able to process the signals from two detectors 56. Eight integrators 76, and indeed four integrators 76 are provided for each intermediate plate 74 on a front side, and four integrators 76 are provided on a rear side of intermediate plate 74. This means that for each plate 74 sixteen detectors 56 can easily be operated, which in this exemplary embodiment results in a reasonable length of intermediate plates 74 (the length is here represented as being perpendicular to the drawing plane in FIGS. 6 to 8).

As can be seen immediately from FIG. 7, integrators 76 are arranged behind lead screen 65, in particular behind regions 72, viewed in the direction of radiation, so that damage to these electrical assemblies can be minimised by the rays from radiation source 50.

Intermediate plate 74 is also provided with standard plugs 77 which guarantee a plug-in connection to a main plate 78 on which are now also arranged logical assemblies and analogue-digital converters (not shown). Here it is self-evident that these electronic and logical assemblies are also arranged in the radiation shadow of lead screen 65 or regions 72 so that damage to three assemblies by radiation can also be minimised.

In this exemplary embodiment the signals from detectors 56 amplified by the operating amplifiers of integrators 76 therefore run directly through plug-in connection 77 to the main plate. The intermediate plate therefore has no logical assemblies. The advantage of this design is that extremely short—and in particular approximately the same distances can be provided between the amplifying assemblies, namely integrators 76 and the assemblies which further process these signals, which is made possible by the three-dimensional structure of intermediate plate 74 and main plate 78. In addition, this arrangement has the advantage, independently of all the other features of this invention, that the distances over which analogue signals must pass, can be minimised.

In this exemplary embodiment the length of main plates 78 is equal to the length of intermediate plates 74, so that detector modules with sixteen detectors 56 are produced. As shown in FIG. 9 by way of example, these detectors may easily be plugged in one above the other inside T-shaped recess 71, each detector module 74 being brought into direct contact due to gravitation. Here the individual detector modules 70 can directly follow a curvature of the entire detector unit or frame 3, 39. Here, in particular, detectors 56 of two detector modules 70 abut seamlessly against each other in this favoured concave curvature, whilst a small gap 79 will remain between plates 74, 78 due to the curvature. It can therefore be guaranteed, even in the case of thermal expansion of the entire arrangement, that in principle detector 56 always lies on detector 56, so that an image is not distorted under such conditions but may vary in resolution if necessary.

According to the specific design, a connection between the individual plates is not absolutely necessary. However, it is an advantage for the individual plates to be connected to each other by a bus system so that measured results can easily and reliably be transmitted to a centre, preferably along the plates. According to the specific requirements the plates, in particular main plates 78, can be connected to each other in an articulated manner, for example by wire connections or the like. Such an articulated connection can also be achieved, for example, by a suitable perforation or other material weakening. If the curvatures are not very sharp, a plurality of intermediate plates 74 may also be combined, for example, on a single main plate 78, which is then designed correspondingly larger—and if necessary has a slight articulation at suitable points as a result of the material weakening described above.

As will be immediately seen in FIG. 7 in particular, a detector module 56 can also easily be replaced through gap 66. On the other hand, replacing the plates is slightly more expensive because they have to be pushed out of the rail or T-shaped recess 71 of lead screen 65. However, since the electronic or logical assemblies are arranged behind screen 65, damage to these assemblies by radiation is minimised, whereas detectors 56 are substantially exposed and are therefore able to measure extremely accurately—and at the same time can be replaced very easily if they should fail, due in particular to the radiation.

In the exemplary embodiment shown in FIG. 11 a vehicle, for example a container or an entire truck, travels on wheels 85 on a flat bottom 83 parallel to a support 86 which support 86 is raised so that it is arranged inside the ray path of a radiation source 50. Radiation source 50 is rigidly arranged on a support arm 80 and rotatably mounted on the carriage by means of a joint 87. A support 88 is arranged on the end of arm 80 facing away from the radiation source, as described above, which support can in turn also be displaced on bottom 83 by means of an auxiliary carriage 89 which has wheels 84.

This arrangement has an angle meter 90 which correct incoming signals 91, which are actually to be fed from the detectors to an image generator 92, in a correction device 93 before entering image generator 92 according to the angle. Thus if auxiliary carriage 89 passes over an obstacle in this arrangement, this results in a variation in the angle of arm 80, but not in a relative displacement between radiation source 50 and the detectors in detector strip 81, so that an image correction can be carried out correspondingly reliably. Because correction device 93 is arranged before the input into image generator 92 the correction process is very simple. In particular, the image generator does not need to be modified relative to the image generators known from the state of the art.

As will be seen immediately, a vertical displacement of frame 80, 88 and radiation source 50 relative to a large object or to support 86 can be measured and corrected by angle meter 90 and correction device 93 respectively.

The exemplary embodiment shown in FIG. 12 corresponds essentially to the exemplary embodiment shown in FIG. 11, so that identically acting assemblies are also identically numbered. Of course this arrangement comprises an arm 96, 97 that can be tilted by hydraulics 95, but the points of articulation of the arm can be fixed by bolts 89. the frame must therefore be regarded as rigid during operation.

The arrangement in FIG. 12 also has two measuring devices 99 which in turn transmit signals to correction device 93 when the arrangement travels over an uneven floor, with the result that a corresponding vertical displacement can easily be measured and corrected.

The arrangement shown in FIG. 13 also corresponds essentially to the arrangement shown in FIG. 11, so that here too identically active assemblies are identically numbered. Of course support arm 100 is rigidly mounted on carriage 82. Moreover, measuring devices 101 measure a deviation of X-ray source 50 or the detectors in detector strip 81 from support 86, with the result that even irregularities that are formed subsequently in bottom 83 cannot falsify the measured result.

1-66. (canceled)

67. An X-ray scanner (1; 3) for large objects (9, 25) such as containers, railway wagons or trucks (9, 25), with at least one laterally arranged radiation source (12) and at least one detector (3, 17; 39), between which rays (13; 38) are able to run along a ray path, and with a support (4; 40) for the large object (9, 25), wherein the support (4; 40) for the large object (9, 25) is arranged inside the ray path (13; 38).

68. The X-ray scanner according to claim 67, wherein the ray path has at least one horizontal ray trace which is provided underneath the support.

69. The X-ray scanner according to claim 67, wherein the radiation source is arranged in and/or underneath a plane incorporating the support.

70. The X-ray scanner according to claim 67, wherein the support comprises a linear conveyor (4, 11) for the large objects or is designed as such.

71. The X-ray scanner according to claim 67, wherein the radiation source and the detector are linearly displaceable, preferably on rails (34, 35, 42).

72. The X-ray scanner according to claim 67, wherein the ray path is provided outside a building.

73. The X-ray scanner according to claim 72, wherein a co-traveling radiation protection, for example a co-traveling concrete wall, is provided behind the detector viewed from the radiation source.

74. An X-ray scanner for large objects such as containers, railway wagons or trucks, with at least one radiation source and at least one detector between which rays are able to run along a ray path, and with a support for the large object, wherein the radiation source (50) and the detector (39) are connected to each other by means of a bridge (3, 14, 15, 16, 17; 37, 39) and are displaceable on rails (34, 35, 42) by means of their own drive.

75. The X-ray scanner according to claim 71, further comprising retaining clips gripping the rails.

76. The X-ray scanner according to claim 71, wherein the radiation source is arranged on a carriage which is mounted in a freestanding manner independently of a bridge.

77. The X-ray scanner according to claim 76, wherein the detector is mounted on a bridge which is displaceably mounted on the stable carriage on the one hand and on an auxiliary carriage (41) on the other.

78. The X-ray scanner according to claim 77, wherein the auxiliary carriage runs over two wheels on the rail.

79. The X-ray scanner according to claim 77, wherein the auxiliary carriage is not driven.

80. An X-ray scanner for large objects such as containers, railway wagons or trucks, with at least one radiation source and at least one detector between which rays are able to run along a ray path, and with a support for the large object, further comprising a protective space (7) for personnel operating the large object (9, 25) is preferably integrated (2; 31) structurally with the X-ray scanner outside the scanning volume (13; 38).

81. The X-ray scanner according to claim 80, wherein the protective space and/or a service space for service personnel can be displaced together with the radiation source or the detector.

82. The X-ray scanner according to claim 81, wherein the radiation source, the service space and the protective space are arranged in a container displaceable on rails.

83. The X-ray scanner according to claim 81, further comprising a footbridge (44) displaceable with the protective space between the support and the protective space.

84. An X-ray scanner for large objects such as containers, railway wagons or trucks, according to claim 80, wherein a path (21, 22, 23; 44, 45) around the radiation source through a protective space (7) is provided outside the ray path (13; 38).

85. The X-ray scanner according to claim 80, wherein the radiation source cannot be activated until the operating personnel are in the protective space.

86. The X-ray scanner according to claim 80, wherein the protective space is designed so that it is bullet, shot and/or impact proof.

87. An X-ray scanner for large objects such as containers, railway wagons or trucks, with at least one radiation source and at least one detector between which rays are able to run along a ray path, and with a support for the large object, further comprising an independent current generator.

88. An X-ray scanner for large objects such as containers, railway wagons or trucks, with at least one radiation source and a multiplicity of detectors, where rays are able to run along a ray path, and with a support for the large object, wherein the detectors are arranged essentially along an arc (17; 39).

89. The X-ray scanner according to claim 88, wherein the detectors are arranged on an arc-shaped frame.

90. The X-ray scanner according to claim 89, wherein the detectors are arranged on a frame in the shape of the arc of a circle.

91. The X-ray scanner according to claim 88, wherein the detectors are arranged in rectilinear detector strips whose central perpendiculars are aligned essentially to the radiation source.

92. The X-ray scanner according to claim 91, wherein the detectors are arranged in rectilinear detector strips whose central perpendiculars are aligned essentially to the radiation source with a deviation of less than 15°.

93. The X-ray scanner according to claim 88, wherein the detectors are arranged in rectilinear detector strips whose centers are essentially spaced equidistantly from the radiation source.

94. The X-ray scanner according to claim 88, wherein the detectors are arranged along the arc of a circle (39).

95. The X-ray scanner according to claim 88, wherein the detectors are displaceable perpendicularly to the ray path together with the radiation source.

96. An X-ray scanner for large objects such as containers, railway wagons or trucks, with at least one radiation source and a multiplicity of detectors, where rays are able to run along a ray path, and with a support for the large object, further comprising means for compensating for a thermal expansion.

97. The X-ray scanner according to claim 96, wherein the compensation means comprise detector rails which are provided on a frame and on which the detectors are displaceably arranged, spring means preferably being provided which act on the detectors parallel to the detector rails.

98. The X-ray scanner according to claim 97, wherein the frame is connected rigidly to the radiation source.

99. The X-ray scanner according to claim 96, wherein the detectors are arranged in detector strips which are arranged above the compensation means on a frame.

100. The X-ray scanner according to claim 96, wherein the compensation means have temperature-stable spacers, for example a housing of the detector strips.

101. The X-ray scanner according to claim 96, wherein the compensation means comprise a thermally insulating housing (14, 15, 16, 17; 37, 39) for the detectors or for the detector strips.

102. An X-ray scanner for large objects such as containers, railway wagons or trucks, with at least one radiation source and a multiplicity of detectors, where rays are able to run along a ray path, and with a support for the large object, further comprising a common housing (14, 15, 16, 17; 37, 39) for the detectors or for detector strips in which the detectors are arranged.

103. The X-ray scanner according to claim 101, wherein the housing comprises a thermal insulation.

104. The X-ray scanner according to claim 101, wherein the housing interior is climatized, in particular actively climatized.

105. The X-ray scanner according to claim 101, wherein the housing is installed on a frame.

106. An X-ray scanner for large objects such as containers, railway wagons or trucks, with at least one radiation source and a multiplicity of detectors, where rays are able to run along a ray path, and with a support for the large object, further comprising a frame (14, 15, 16, 17; 37, 39) for the detectors, which frame is connected essentially rigidly (19) to the radiation source (50).

107. The X-ray scanner according to claim 106, wherein the frame is connected rigidly to the radiation source except for a thermal compensation.

108. The X-ray scanner according to claim 106, wherein the detectors are connected to the frame except for a thermal compensation.

109. The X-ray scanner according to claim 106, wherein the detectors and the radiation source can be displaced linearly along a path relative to the large object, and in that the frame is arranged horizontally inclined by an angle (49) that is smaller than 900 relative to the path (11; 48).

110. The X-ray scanner according to claim 106, further comprising a measuring device (90, 99, 101) for measuring a vertical displacement of the frame and Radiation source relative to the large object or relative to the support.

111. The X-ray scanner according to claim 106, further comprising a correction device (93) for correcting a vertical displacement of the frame and Radiation source relative to the large object or relative to the support.

112. The X-ray scanner according to claim 111, wherein the correction device (93) is arranged before the input into an image generator (92).

113. An X-ray scanner for large objects such as containers, railway wagons or trucks, with at least one radiation source and a multiplicity of detectors, where rays are able to run along a ray path, and with a support for the large object, wherein the ray path is horizontally inclined by an angle (49) of less than 900 relative to the path (11; 48) along which the detectors and the radiation source can be displaced relative to the large object.

114. The X-ray scanner according to claim 113, wherein the ray path is arranged in a vertical plane.

115. An X-ray scanner for large objects such as containers, railway wagons or trucks, with at least one radiation source and at least one detector between which rays are able to run along a ray path, and with a support for the large object, wherein the radiation source is arranged in a standard container, preferably in a 20 foot container or in a 40 foot container.

116. The X-ray scanner according to claim 115, wherein a service space for service personnel of the X-ray scanner and/or a protective space for operating personnel of the large object, e.g. a truck driver or a locomotive driver, are arranged in the container.

117. The X-ray scanner according to claim 115, wherein the container can be driven on rails.

118. The X-ray scanner according to claim 115, wherein the radiation source is arranged in a separate space in the container.

119. The X-ray scanner according to claim 118, wherein the separate space is screened with the exception of an exit gap for the ray path.

120. The X-ray scanner according to claim 115, wherein the radiation source is screened with the exception of an exit gap for the ray path.

121. An X-ray scanner for large objects such as containers, railway wagons or trucks, with at least one radiation source and at least one detector between which rays are able to run along a ray path, and with a support for the large object, wherein the radiation source is screened, bundled and/or directed (51) so that the ray width is no more than twice as wide as the detector or detector strip at the height of the detector or at the height of at least one detector strip.

122. The X-ray scanner according to claim 121, wherein the radiation source and the detector are movably arranged and in that a co-traveling radiation protection, for example a co-traveling concrete wall, is provided behind the detector viewed form the radiation source.

123. The X-ray scanner according to claim 121, wherein the radiation source (50) and the detector are movably arranged and a fixed radiation protection, for example a concrete wall, is provided behind the detector viewed from the radiation source.

124. The X-ray scanner according to claim 121, wherein the radiation source (50) is an X-ray source, a gamma ray source and/or a neutron source.

125. An X-ray scanner for large objects such as containers, railway wagons or trucks, with at least one radiation source and at least one detector between which rays are able to run along a ray path, and with a support for the large object wherein the ray path (scanning space 13, 38) passes through a series collimator (51).

126. The X-ray scanner according to claim 125, wherein the series collimator (51) is arranged behind a source collimator (53).

127. The X-ray scanner according to claim 126, wherein the series collimator (51) is connected directly to the source collimator (53).

128. The X-ray scanner according to claim 67, wherein the ray path passes through at least one ray trap.

129. The X-ray scanner according to claim 67, wherein the at least one detector (56) is arrange don a logic-free detector module which is connected releasably in a destruction-free manner to a support.

130. The X-rays scanner according to claim 125, wherein the detector module is designed in an electronic-free manner.

131. The X-ray scanner according to claim 125, wherein the detector module has no more than 32 detectors (56), preferably no more than 16 detectors (56).

132. The X-ray scanner according to claim 125, wherein the connection of the detector module to its support is a plug-in connection.

133. The X-ray scanner according to claim 125, wherein the plug-in connection is designed so that it is electrically conducting.

134. The X-ray scanner according to claim 125, wherein the support is a logic-free intermediate support which is arranged on a main support with measuring electronics.

135. The X-ray scanner according to claim 67, wherein the at least one detector (56) is arranged on a module unit with no more than 32 detectors (56), preferably no more than 16 detectors (56), and in that this module unit is connected to at least one further module unit by means of a bus connection.

136. The X-ray scanner according to claim 67, wherein the at least one detector (56) is arranged on a module unit with no more than 32 detectors (56), preferably no more than 16 detectors (56), and in that this module unit is movably mounted on at least one further module unit.
